(19) United States
(12) Patent Application Publication
(10) Pub. No.: US 2026/0214765 A1
(43) Pub. Date: Jul. 23, 2026

(54) HIGHLY COMPATIBLE POWER CONTROLLER

(71) Applicant: Xiamen PVTECH Co., Ltd., Xiamen (CN)

(72) Inventors: RONGTU LIU, Xiamen (CN); FUXING LU, Xiamen (CN); CHUNMING LIU, Xiamen (CN)

(21) Appl. No.: 19/567,142

(22) Filed: Mar. 15, 2026

Related U.S. Application Data
(63) Continuation-in-part of application No. 19/012,882, filed on Jan. 8, 2025.

(30) Foreign Application Priority Data
Jan. 4, 2026 (CN) 202620002480.3

(51) Int. Cl. H05B 45/3725; H02M 1/00; H02M 1/44; H05B 45/56

(52) U.S. Cl. CPC H05B 45/3725; H02M 1/0009; H02M 1/0058; H02M 1/44; H05B 45/56

(57) ABSTRACT

A power controller includes a signal identification element, a switch driver, and a switch element. The signal identification element includes a high-frequency signal identifier for receiving a first input signal. The high-frequency signal identifier includes a voltage divider, an inverter, a first comparator, a second comparator, a latch, and an AND gate. The switch driver is connected to the high-frequency signal identifier. The switch element is connected to the switch driver. The circuit design of the high-frequency signal identifier can perform a noise reduction function and a multi-condition software logic operation mechanism in order to generate a conduction signal. The switch driver activates the switch element according to the conduction signal.

### TECHNICAL FIELD

The disclosure relates to a controller, in particular to a highly compatible power controller.

### BACKGROUND

In currently available LED lighting devices compatible with electronic ballasts, high-frequency signals are susceptible to multiple factors such as electromagnetic interference, power supply noise, and signal reflections, which easily cause signal jitter. Such phenomena may lead to malfunction of LED driver chips, unstable light output, or reduced energy efficiency, and in severe cases may even result in failure of the lighting device.

Most currently available LED lighting devices attempt to address the above issues by using filtering circuits with fixed delays or decision mechanisms based on static thresholds. However, in high-frequency operating environments with substantial dynamic noise, such solutions have difficulty achieving an effective balance between system response speed and interference immunity, and therefore fail to satisfy actual requirements.

### SUMMARY

One embodiment of the disclosure provides a highly compatible power controller, which includes a signal identification element, a switch driver, and a switch element. The signal identification element includes a high-frequency signal identifier for receiving a first input signal. The high-frequency signal identifier includes a voltage divider, an inverter, a first comparator, a second comparator, a latch, and an AND gate. The switch driver is connected to the high-frequency signal identifier. The switch element is connected to the switch driver. The voltage divider divides the first input signal to generate a first divided-voltage signal. The inverter performs noise suppression on the first divided-voltage signal to generate a second divided-voltage signal. The first comparator compares the second divided-voltage signal with a first reference voltage and generates a first comparison signal at low level when the second divided-voltage signal is lower than the first reference voltage. The second comparator compares the second divided-voltage signal with a second reference voltage and generates a second comparison signal at high level when the second divided-voltage signal is higher than the second reference voltage. The latch generates a logic output signal at high level according to the first comparison signal and the second comparison signal. The AND gate generates a conduction signal when both the logic output signal and the second comparison signal are at high level. The switch driver activates the switch element according to the conduction signal.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is the block diagram of the circuit structure of the highly compatible power controller in accordance with the first embodiment of the disclosure.

FIG. 2 is the block diagram of the circuit structure of the high-frequency signal identifier of the highly compatible power controller in accordance with the first embodiment of the disclosure.

FIG. 3 is the block diagram of the circuit structure of the highly compatible power controller in accordance with the second embodiment of the disclosure.

FIG. 4 is the block diagram of the circuit structure of the highly compatible power controller in accordance with the third embodiment of the disclosure.

FIG. 5 is the block diagram of the circuit structure of the highly compatible power controller in accordance with the fourth embodiment of the disclosure.

FIG. 6 is the block diagram of the circuit structure of the highly compatible power controller in accordance with the fifth embodiment of the disclosure.

FIG. 7 is the block diagram of the circuit structure of the highly compatible power controller in accordance with the sixth embodiment of the disclosure.

FIG. 8 is the circuit diagram of the lighting device driver having the power controller in accordance with the sixth embodiment of the disclosure.

FIG. 9 is the schematic view of the utility power mode of the lighting device driver having the power controller in accordance with the sixth embodiment of the disclosure.

FIG. 10 is the schematic view of the ballast mode of the lighting device driver having the power controller in accordance with the sixth embodiment of the disclosure.

FIG. 11 is the block diagram of the circuit structure of the high-frequency signal identifier of the highly compatible power controller in accordance with the seventh embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

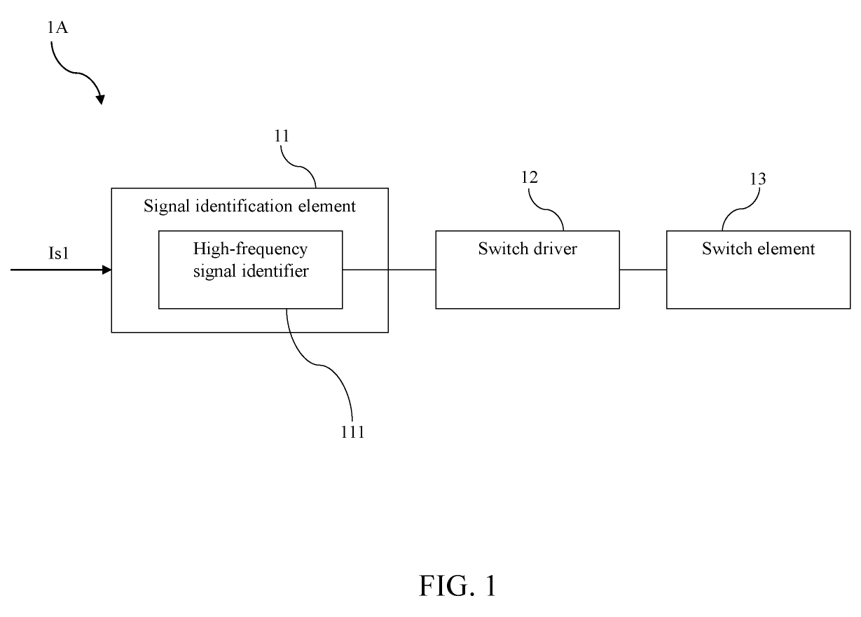

Please refer to FIG. 1, which is the block diagram of the circuit structure of the highly compatible power controller in accordance with the first embodiment of the disclosure. As shown in FIG. 1, the power controller 1A includes a signal identification element 11, a switch driver 12, and a switch element 13.

The signal identification element 11 includes a high-frequency signal identifier 111. The high-frequency signal identifier 111 receives the first input signal Is1.

The switch driver 12 is connected to the high-frequency signal identifier 111. In this embodiment, the switch driver 12 may be a gate driver. In another embodiment, the switch driver 12 may be a signal amplifier or other components with signal amplification capabilities.

The switch element 13 is connected to the switch driver 12. In this embodiment, the switch element 13 may be a metal-oxide-semiconductor field-effect transistor (MOSFET). In another embodiment, the switch element 13 may also be a bipolar junction transistor (BJT) or other similar components.

The high-frequency signal identifier 111 executes a counting process within a preset time interval, which includes a preset number of counting cycles, to detect the number of sine waves in the first input signal Is1. The high-frequency signal identifier 111 generates a conduction signal when the number of sine waves in any counting cycle is greater than or equal to a preset threshold. The switch driver 12 activates the switch element 13 according to the conduction signal. The high-frequency signal identifier 111 then enters a deadlock state to stop the counting process.

Conversely, when the number of sine waves in each counting cycle is less than the preset threshold, the high-frequency signal identifier 111 enters a deadlock state, stopping the counting process.

Via the above counting mechanism and the specialized decision logic, the power controller 1 can effectively determine whether the first input signal Is1 is a signal from the ballast GH. When the number of sine waves in any counting cycle is greater than or equal to the preset threshold, the power controller 1 determines that the first input signal Is1 is a signal from the ballast GH, generates a conduction signal to activate the switch element 13, and outputs a direct-current signal. In this case, the power controller 1 operates in the ballast mode. The conduction signal mentioned above may be a direct-current signal, keeping the switch element 13 in the on state.

Conversely, when the number of sine waves in each counting cycle is less than the preset threshold, and the switch driver 12 activates the switch element 13 according to the conduction signal, the power controller 1 determines that the first input signal Is1 is noise. This noise may result from poor external switch contact or other factors. At this point, the high-frequency signal identifier 111 enters a deadlock state without generating a conduction signal to prevent the power controller 1 from malfunctioning.

The embodiment just exemplifies the disclosure and is not intended to limit the scope of the disclosure; any equivalent modification and variation according to the spirit of the disclosure is to be also included within the scope of the following claims and their equivalents.

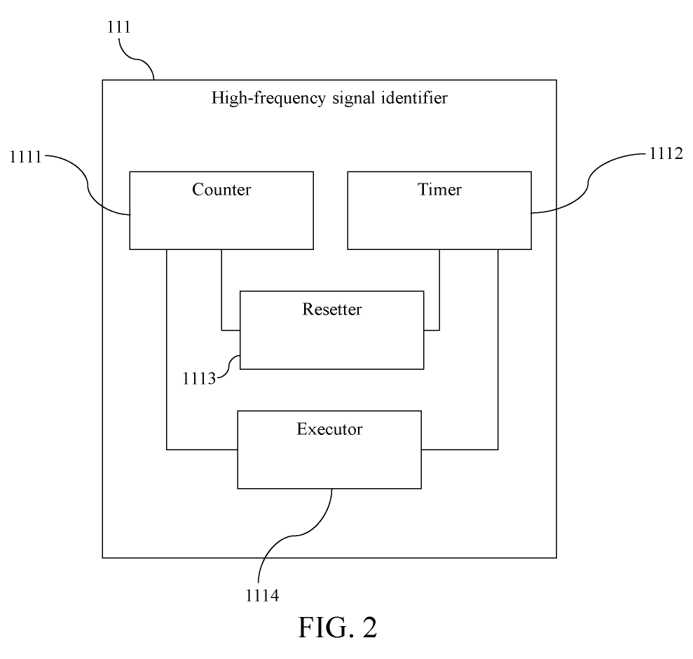

Please refer to FIG. 2, which is the block diagram of the circuit structure of the high-frequency signal identifier of the highly compatible power controller in accordance with the first embodiment of the disclosure. As shown in FIG. 2, the high-frequency signal identifier 111 includes a counter 1111, a timer 1112, a resetter 1113, and an executor 1114.

The resetter 1113 is connected to the counter 1111 and the timer 1112. The counter 1111 and the timer 1112 are common integrated circuits and can be implemented using any existing circuit design, so no further details are provided here. The resetter 1113 may be a circuit with one or more of a resistor, a capacitor, or a diode.

The executor 1114 is connected to the counter 1111 and the timer 1112. The executor 1114 may be a circuit with one or more of a resistor, a capacitor, or a diode.

As mentioned earlier, the high-frequency signal identifier 111 can execute the counting process within a preset time interval. The counting process includes a preset number of counting cycles. When the high-frequency signal identifier 111 receives the first input signal Is1, the timer 1112 controls the executor 1114 to generate an execution signal to control the counter 1111 to execute the counting process and calculate the number of sine waves in the first input signal Is1. It also determines whether the number of sine waves in each counting cycle is greater than or equal to the preset threshold. The timer 1112 controls the duration of each counting cycle and, at the end of each cycle, controls the resetter 1113 to generate a reset signal to reset the counter 1111 for the next counting cycle.

For example, if the frequency threshold of the high-frequency signal identifier 111 is 20 kHz, and the frequency is not lower than 20 kHz, the high-frequency signal identifier 111 outputs a conduction signal to the switch driver 12, enabling the switch driver 12 to activate the switch element 13 based on the conduction signal. In this case, the sine wave period of the single high-frequency signal is 50 µs. The timer 1112 sets the counting cycle to 200 µs, and the preset time interval is 2000 µs. Thus, the counting process can include 10 counting cycles, and the preset threshold can be 4 (or 3).

When the number of sine waves in any counting cycle is greater than or equal to 4, the high-frequency signal identifier 111 determines that the first input signal Is1 meets the frequency threshold (20 kHz) and outputs a conduction signal to the switch driver 12, enabling the switch driver 12 to activate the switch element 13 to execute the ballast mode.

Conversely, when the number of sine waves in each counting cycle is less than 4, the high-frequency signal identifier 111 determines that the first input signal Is1 does not meet the frequency threshold (20 kHz) and may be noise. At this point, the high-frequency signal identifier 111 enters a deadlock state without generating a conduction signal.

In another embodiment, the timer 1112 sets a counting cycle to 300 µs, and the preset time interval is 1500 µs. Thus, the counting process can include 5 counting cycles, and the preset threshold can be 6 (or 5). The sine wave period, counting cycle, preset time interval, and preset threshold mentioned above are examples and can be modified according to actual requirements.

Through the above circuit design, the high-frequency signal identifier 111 can achieve a highly efficient counting process, enabling the power controller 1 to effectively determine whether the first input signal Is1 is noise or a signal from the ballast GH, thereby preventing the power controller 1 from malfunctioning.

The embodiment just exemplifies the disclosure and is not intended to limit the scope of the disclosure; any equivalent modification and variation according to the spirit of the disclosure is to be also included within the scope of the following claims and their equivalents.

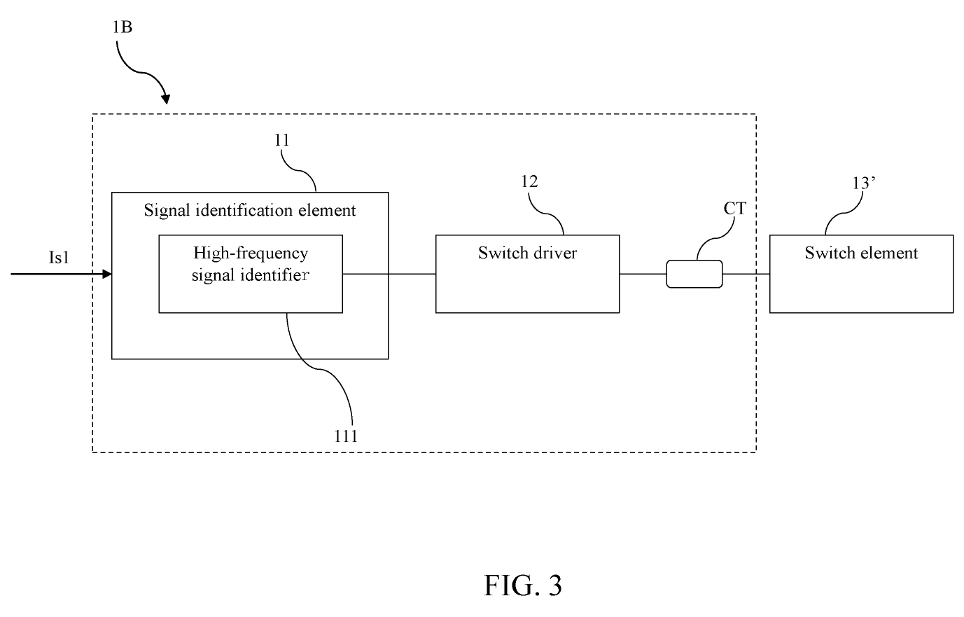

Please refer to FIG. 3, which is the block diagram of the circuit structure of the highly compatible power controller in accordance with the second embodiment of the disclosure. As shown in FIG. 3, the power controller 1B includes a signal identification element 11 and a switch driver 12. The signal identification element 11 includes a high-frequency signal identifier 111. The switch driver 12 is connected to the high-frequency signal identifier 111. The functions of these components are the same as in the previous embodiment and will not be further elaborated here.

The difference between this embodiment and the first embodiment is that the power controller 1B further includes a port CT. The power controller 1B does not have a built-in switch element 13 but instead connects to an external switch element 13' via the port CT.

Similarly, the power controller 1B can execute the above-described counting process and decision logic to effectively determine whether the first input signal Is1 is a signal for the ballast GH or noise. When the power controller 1B determines that the first input signal Is1 is a signal from ballast GH, the power controller 1B operates in the ballast mode to drive the load. Conversely, when the power controller 1B determines that the first input signal Is1 is noise, the power controller 1B enters a deadlock state and does not generate a conduction signal.

The embodiment just exemplifies the disclosure and is not intended to limit the scope of the disclosure; any equivalent modification and variation according to the spirit of the disclosure is to be also included within the scope of the following claims and their equivalents.

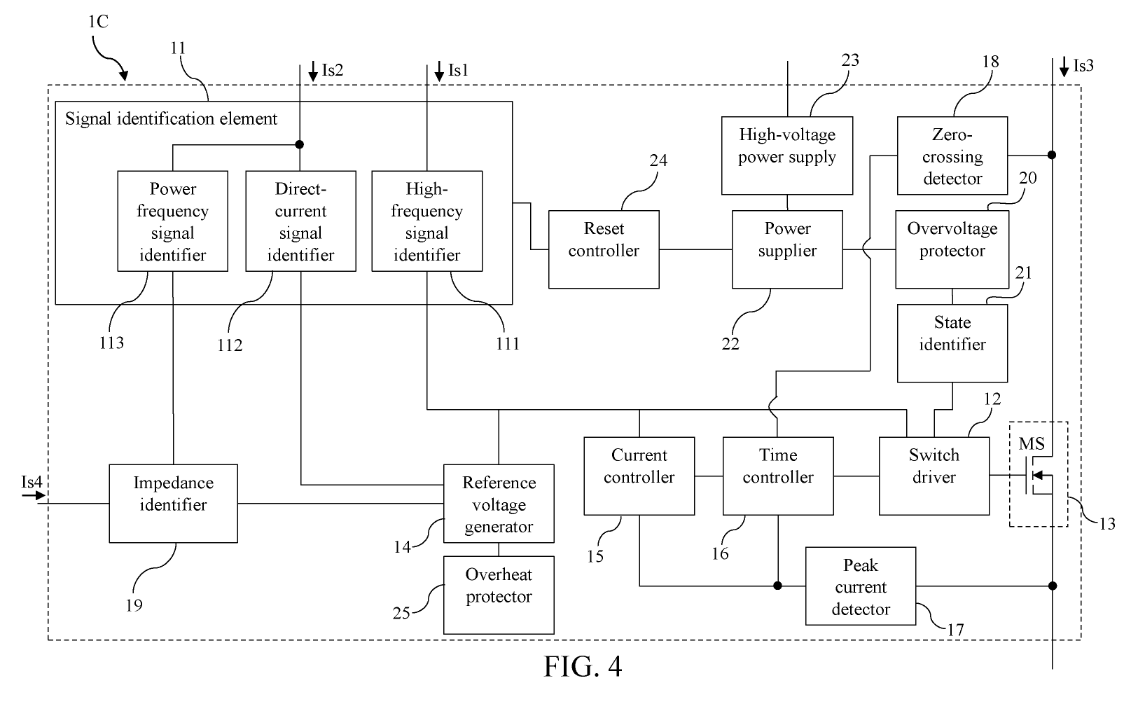

Please refer to FIG. 4, which is the block diagram of the circuit structure of the highly compatible power controller in accordance with the third embodiment of the disclosure. As shown in FIG. 4, the power controller 1C includes a signal identification element 11, a switch driver 12, and a switch element 13. The signal identification element 11 includes a high-frequency signal identifier 111.

The difference between this embodiment and the first embodiment is that the signal identification element 11 further includes a direct-current signal identifier 112 and a power frequency signal identifier 113. Additionally, the power controller 1C includes a reference voltage generator 14, a current controller 15, a time controller 16, a peak current detector 17, a zero-crossing detector 18, an impedance identifier 19, an overvoltage protector 20, a state identifier 21, a power supplier 22, a high-voltage power supply 23, a reset controller 24, and an overheat protector 25. Since the direct-current signal identifier 112, power frequency signal identifier 113, and other listed components have already been applied in currently available power controllers, the circuit structures thereof will not be further elaborated. Furthermore, in this embodiment, the switch element 13 is a transistor MS, which is a metal-oxide-semiconductor field-effect transistor.

The high-voltage power supply 23 is connected to the power supplier 22. The power supplier 22 is connected to the reset controller 24 and the overvoltage protector 20. The overvoltage protector 20 is connected to the state identifier 21. The state identifier 21 is connected to the switch driver 12.

The high-voltage power supply 23 divides the rectified DC voltage to generate a driving voltage. The power supplier 22 steps down and regulates the driving voltage. When the high-voltage power supply 23 is powered on, the reset controller 24 resets all components of the power controller 1C. The overvoltage protector 20 detects whether there is an overvoltage or undervoltage condition to generate a status detection signal. The state identifier 21 restarts or deadlocks the switch driver 12 according to the status detection signal.

The direct-current signal identifier 112 is connected to the reference voltage generator 14. The reference voltage generator 14 is connected to the current controller 15. The current controller 15 is connected to the time controller 16 and the peak current detector 17. The time controller 16 is connected to the zero-crossing detector 18, the peak current detector 17, and the switch driver 12.

The direct-current signal identifier 112 receives the second input signal Is2 and outputs a direct-current identification signal to the reference voltage generator 14 when determining that the second input signal Is2 is a direct-current signal, thereby generating a reference voltage. The peak current detector 17 detects the peak current when the switch element 13 is turned on and generates a peak current detection signal. The current controller 15 generates a current control signal according to the reference voltage and the peak current detection signal. The time controller 16 generates the first pulse-width modulation signal according to the current control signal, peak current detection signal, and the third input signal Is3 from the zero-crossing detector 18 to control the switch driver 12 in operating the switch element 13. This mode is the direct-current power mode (which is compatible with adapters, batteries, and other DC power sources).

The power frequency signal identifier 113 is connected to the impedance identifier 19. The impedance identifier 19 is connected to the reference voltage generator 14. The power frequency signal identifier 113 receives the second input signal Is2 and outputs a power frequency identification signal to the impedance identifier 19 when determining that the second input signal Is2 is a power frequency signal. The impedance identifier 19 outputs an impedance identification signal to the reference voltage generator 14 according to the fourth input signal Is4 to generate a reference voltage. The current controller 15 generates a current control signal according to the reference voltage and the peak current detection signal. The time controller 16 generates the second pulse-width modulation signal based on the current control signal, peak current detection signal, and zero-crossing detection signal to control the switch driver 12 in operating the switch element 13. This mode is the utility power mode (compatible with utility power).

The overheat protector 25 detects the temperature of the power controller 1C and transmits an overheat protection signal to the reference voltage generator 14 to reduce the reference voltage when the temperature exceeds a threshold value, thereby performing temperature regulation.

The power controller 1C can perform the utility power mode or the direct-current power mode through the aforementioned components. Therefore, the power controller 1C is compatible with ballast GH, utility power, and direct-current power sources (such as adapters and batteries) without requiring additional detection circuits, achieving high compatibility. Furthermore, the complexity of the drive circuit is thereby reduced, allowing the power controller 1C to be miniaturized and lowering manufacturing costs.

The embodiment just exemplifies the disclosure and is not intended to limit the scope of the disclosure; any equivalent modification and variation according to the spirit of the disclosure is to be also included within the scope of the following claims and their equivalents.

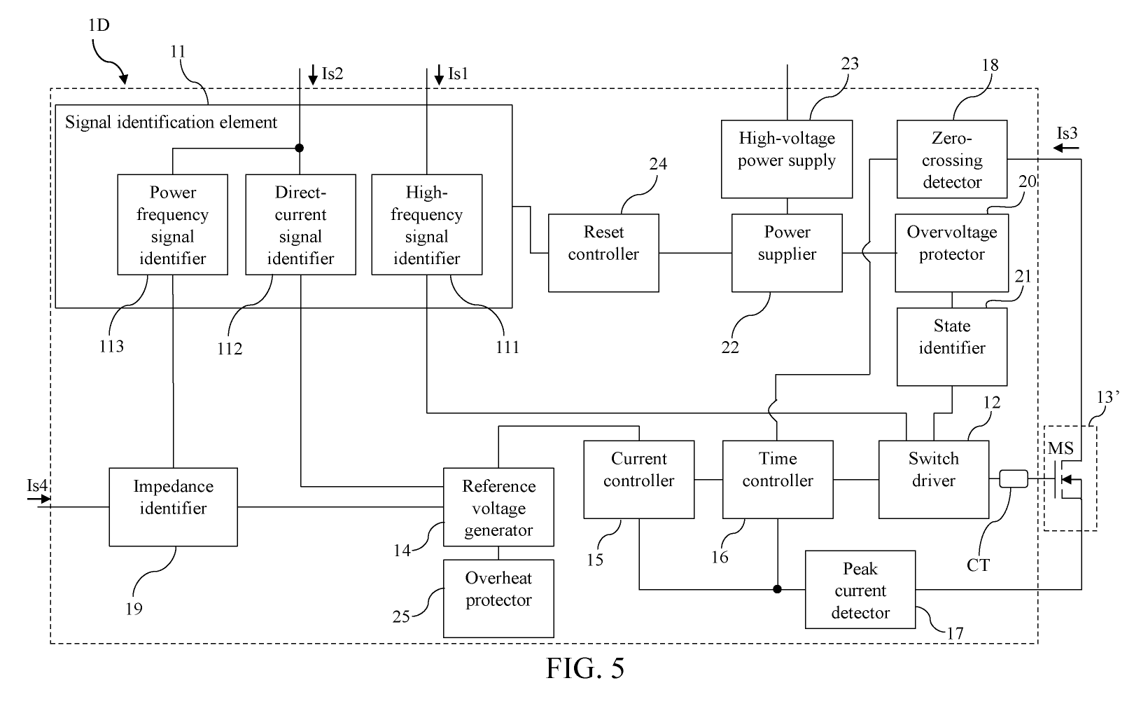

Please refer to FIG. 5, which is the block diagram of the circuit structure of the highly compatible power controller in accordance with the fourth embodiment of the disclosure. As shown in FIG. 5, the power controller 1D includes a signal identification element 11, a switch driver 12, a reference voltage generator 14, a current controller 15, a time controller 16, a peak current detector 17, a zero-crossing detector 18, an impedance identifier 19, an overvoltage protector 20, a state identifier 21, a power supplier 22, a high-voltage power supply 23, a reset controller 24, and an overheat protector 25. The signal identification element 11 includes a high-frequency signal identifier 111, a direct-current signal identifier 112, and a power frequency signal identifier 113.

The functions of these components are the same as in the previous embodiments and will not be further elaborated. Unlike the third embodiment, the power controller 1D further includes a port CT. The power controller 1 does not have a built-in switch element 13 but instead connects to an external switch element 13' through the port CT. In this embodiment, the switch element 13' is a transistor MS, which is a metal-oxide-semiconductor field-effect transistor.

The embodiment just exemplifies the disclosure and is not intended to limit the scope of the disclosure; any equivalent modification and variation according to the spirit of the disclosure is to be also included within the scope of the following claims and their equivalents.

As previously stated, according to one embodiment of the disclosure, the power controller includes a signal identification element, a switch driver, and a switch element. The signal identification element includes a high-frequency signal identifier for receiving a first input signal. The switch driver is connected to the high-frequency signal identifier. The switch element is connected to the switch driver. The high-frequency signal identifier executes a counting process within a preset time interval. The counting process includes a preset number of counting cycles for detecting the number of sine waves in the first input signal. The high-frequency signal identifier generates a conduction signal when the number of sine waves in any one of the counting cycles is greater than or equal to a preset threshold, and the switch driver activates the switch element according to the conduction signal. Through the above counting mechanism and the specialized decision-making logic thereof, the power controller can effectively determine whether the first input signal is a ballast signal and, if so, execute the ballast mode to drive the load. In this way, the power controller can be compatible with ballasts so as to meet actual requirements.

According to one embodiment of the disclosure, the high-frequency signal identifier of the power controller enters a deadlock state, halting the counting process, when the number of sine waves in each counting cycle is less than the preset threshold. Via the above counting mechanism and the specialized decision-making logic thereof, the power controller can effectively determine whether the first input signal is noise. If the first input signal is determined to be noise (e.g., caused by poor external switch contact or other factors), the system enters a deadlock state and does not generate a conduction signal. Thus, the high-frequency signal identifier can effectively prevent the power controller from malfunctioning, ensuring high reliability.

Also, according to one embodiment of the disclosure, the high-frequency signal identifier of the power controller comprises a counter, a timer, a resetter, and an executor. The resetter is connected to the counter and the timer, while the executor is connected to the counter and the timer. The timer controls the executor to generate an execution signal to direct the counter to execute the counting process and calculate the number of sine waves in the first input signal. The timer also controls the duration of each counting cycle and, at the end of each cycle, controls the resetter to generate a reset signal to reset the counter for the next cycle. Therefore, the high-frequency signal identifier can achieve a highly efficient counting process through a simple circuit design, enabling the power controller to effectively distinguish whether the first input signal is noise or a ballast signal.

Further, according to one embodiment of the disclosure, the power controller further includes a reference voltage generator, a current controller, a time controller, a peak current detector, a zero-crossing detector, and an impedance identifier. The signal identification component also includes a direct-current signal identifier and a power frequency signal identifier. Thus, the power controller can execute either a utility power mode or a direct-current power mode through the above components. Consequently, the power controller is compatible with ballasts, utility power, and direct-current power sources (e.g., adapters, batteries) without requiring additional detection circuits, thereby achieving high compatibility. Moreover, the complexity of the driver circuit is reduced, enabling the power controller to achieve miniaturization and lower manufacturing costs.

Moreover, according to one embodiment of the disclosure, the switch element of the power controller may also be an external switch element. The power controller can include a port through which the switch driver connects to the external switch element. Thus, the power controller can be configured with either an integrated switch element or an external switch element, depending on practical requirements, such that the power controller can conform to the requirements of different applications.

Furthermore, according to one embodiment of the disclosure, the power controller can achieve the desired functionality through a simple circuit design and operational mechanism. As a result, it not only reduces manufacturing costs but also achieves the intended performance. This significantly enhances the practicality of the power controller, making it more versatile in application and more flexible in use. As described above, the highly compatible power controller according to the embodiments of the disclosure can achieve great technical effects.

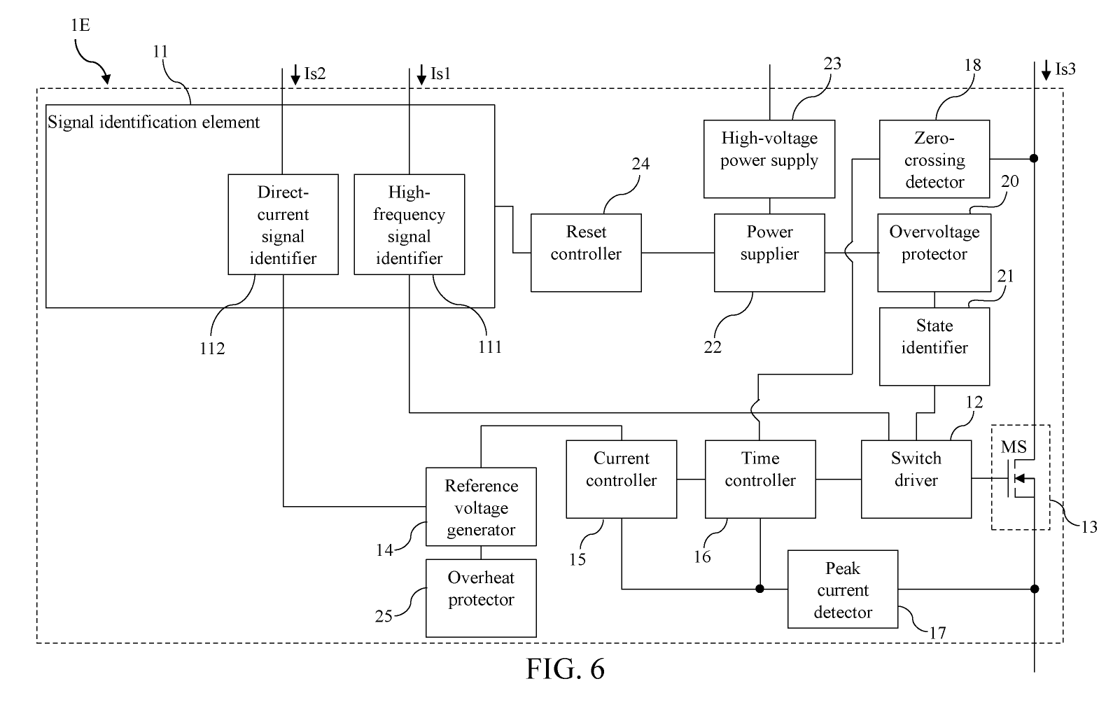

Please refer to FIG. 6, which is the block diagram of the circuit structure of the highly compatible power controller in accordance with the fifth embodiment of the disclosure. As shown in FIG. 6, the difference between this embodiment and the third embodiment is that the signal identification element 11 of the power controller 1E includes a high-frequency signal identifier 111 and a direct-current signal identifier 112 but does not include a power frequency signal identifier 113. Additionally, the power controller 1E does not include an impedance identifier 19.

The embodiment just exemplifies the disclosure and is not intended to limit the scope of the disclosure; any equivalent modification and variation according to the spirit of the disclosure is to be also included within the scope of the following claims and their equivalents.

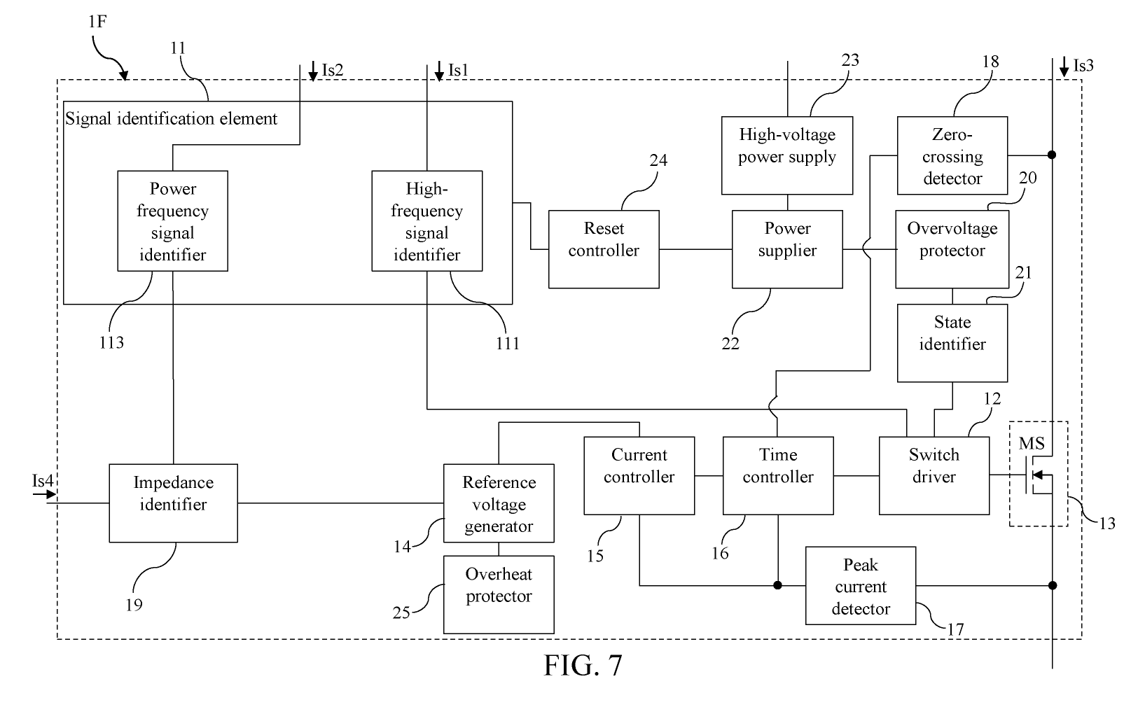

Please refer to FIG. 7, which is the block diagram of the circuit structure of the highly compatible power controller in accordance with the sixth embodiment of the disclosure. As shown in FIG. 7, the difference between this embodiment and the third embodiment is that the signal identification element 11 of the power controller 1F includes a high-frequency signal identifier 111 and a power frequency signal identifier 113 but does not include a direct-current signal identifier 112.

The embodiment just exemplifies the disclosure and is not intended to limit the scope of the disclosure; any equivalent modification and variation according to the spirit of the disclosure is to be also included within the scope of the following claims and their equivalents.

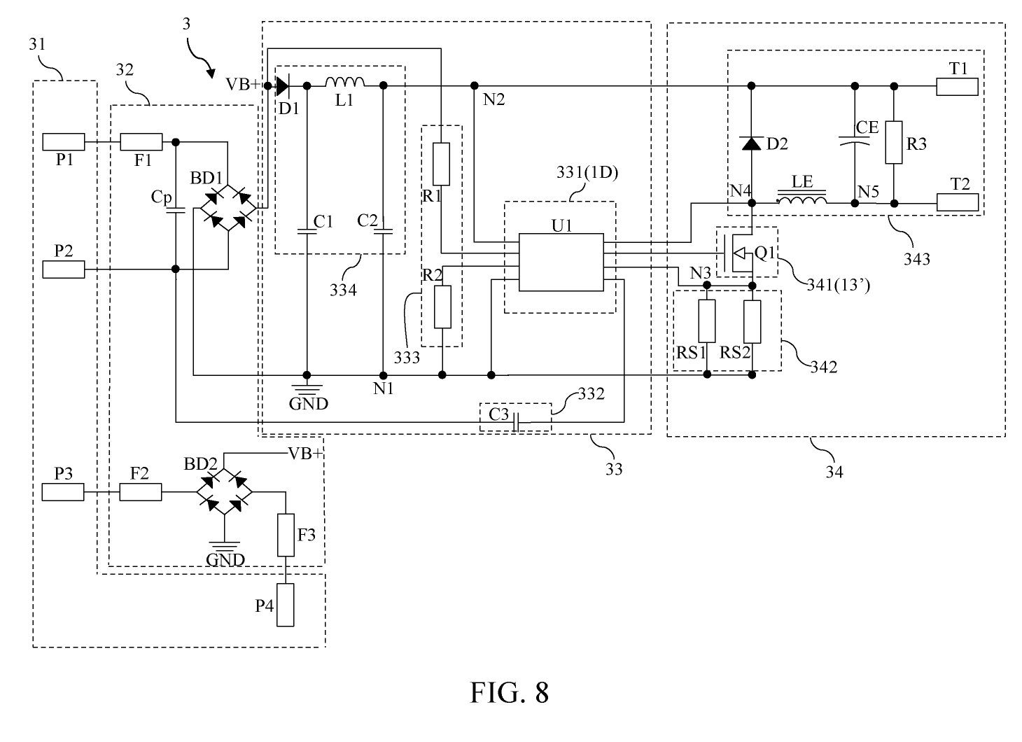

Please refer to FIG. 8, which is the circuit diagram of the lighting device driver having the power controller in accordance with the sixth embodiment of the disclosure. FIG. 8 provides an example of the circuit structure of the lighting device driver 3. This embodiment is for illustrative purposes only; the circuit structures of the input module 31, rectification module 32, driving control module 33, and power conversion module 34 can be modified as needed, and the disclosure is not limited thereto. As shown in FIG. 8, the lighting device driver 3 includes an input module 31, a rectification module 32, a driving control module 33, and a power conversion module 34.

The input module 31 includes a first input terminal P1, a second input terminal P2, a third input terminal P3, and a fourth input terminal P4.

The rectification module 32 is connected to the input module 31 and includes a first rectifier BD1, a second rectifier BD2, a first fuse F1, a second fuse F2, a third fuse F3, and a capacitor Cp. The first end of the first rectifier BD1 is connected to the second input terminal P2; the second end of the first rectifier BD1 is connected to the rectified signal output terminal VB+; the third end of the first rectifier BD1 is connected to the first input terminal P1 via the first fuse F1; and the fourth end of the first rectifier BD1 is connected to the first node N1. The first node N1 is connected to the ground GND. The first end of the second rectifier BD2 is connected to the fourth input terminal P4 via the third fuse F3; the second end of the second rectifier BD2 is connected to the rectified signal output terminal VB+; the third end of the second rectifier BD2 is connected to the third input terminal P3 via the second fuse F2; and the fourth end of the second rectifier BD2 is connected to the ground GND. In one embodiment, the first rectifier BD1 and the second rectifier BD2 can be bridge rectifiers (full-wave or half-wave rectifiers). In another embodiment, they can also be bipolar junction transistors, circuits incorporating bipolar junction transistors, or any other currently available circuits or electronic components with rectification functions.

The driving control module 33 is connected to the rectification module 32 and includes a control unit 331, a signal identification unit 332, an impedance identification and detection unit 333, and a direct-current signal smoothing unit 334, which are connected to each other. The control unit 331 may have at least one signal identification interface and is connected to the signal identification unit 332 via this interface. The control unit 331 includes a controller U1, which may serve as the power controller 1D of the fourth embodiment (the power controller 1D of the fourth embodiment is connected to an external switch element 13’). The direct-current signal smoothing unit 334 includes a first diode D1, an inductor L1, a first capacitor C1, and a second capacitor C2. The anode of the first diode D1 is connected to the rectified signal output terminal VB+, and the cathode thereof is connected to one end of the inductor L1, which is further connected to the first node N1 via the first capacitor C1. The other end of the inductor L1 is connected to the second node N2, which is further connected to the first node N1 via the second capacitor C2. The impedance identification and detection unit 333 includes a plurality of resistors connected in series. In this embodiment, the impedance identification and detection unit 333 includes a first resistor R1 and a second resistor R2. The two ends of the first resistor R1 are connected to the rectified signal output terminal VB+ and the control unit 331, respectively. The two ends of the second resistor R2 are connected to the control unit 331 and the first node N1, respectively. The signal identification unit 332 includes a third capacitor C3, which is connected to the first input terminal P1 via the capacitor Cp, enabling a portion of the input signal Is’, to couple to the third capacitor C3 (the signal identification unit 332). In another embodiment, the control unit 331 may also serve as the power controller 1A, 1B, 1C, 1E, or 1F of the first, second, third, fifth, or sixth embodiments.

The power conversion module 34 is connected to the control unit 331. The power conversion module 34 includes a switching unit 341, a sampling unit 342, and an output unit 343. The switching unit 341 includes a switch Q1 (which serves as the external switch element 13’ of the fourth embodiment), and may be a metal-oxide-semiconductor field-effect transistor. Alternatively, the switch Q1 can also be a bipolar junction transistor or other similar components. The first end of the switch Q1 is connected to the control unit 331, the second end of the switch Q1 is connected to the third node N3, and the third end of the switch Q1 is connected to the fourth node N4. Both the third node N3 and the fourth node N4 are connected to the control unit 331. The output unit 343 includes a second diode D2, an energy storage inductor LE, an electrolytic capacitor CE, a third resistor R3, a first output terminal T1, and a second output terminal T2. The anode and cathode of the second diode D2 are connected to the fourth node N4 and the second node N2, respectively. The two ends of the energy storage inductor LE are connected to the fourth node N4 and the fifth node N5, respectively. The two ends of the electrolytic capacitor CE are connected to the fifth node N5 and the second node N2, respectively. The two ends of the third resistor R3 are connected to the fifth node N5 and the second node N2, respectively. The second node N2 and the fifth node N5 are connected to the first output terminal T1 and the second output terminal T2, respectively.

The embodiment just exemplifies the disclosure and is not intended to limit the scope of the disclosure; any equivalent modification and variation according to the spirit of the disclosure is to be also included within the scope of the following claims and their equivalents.

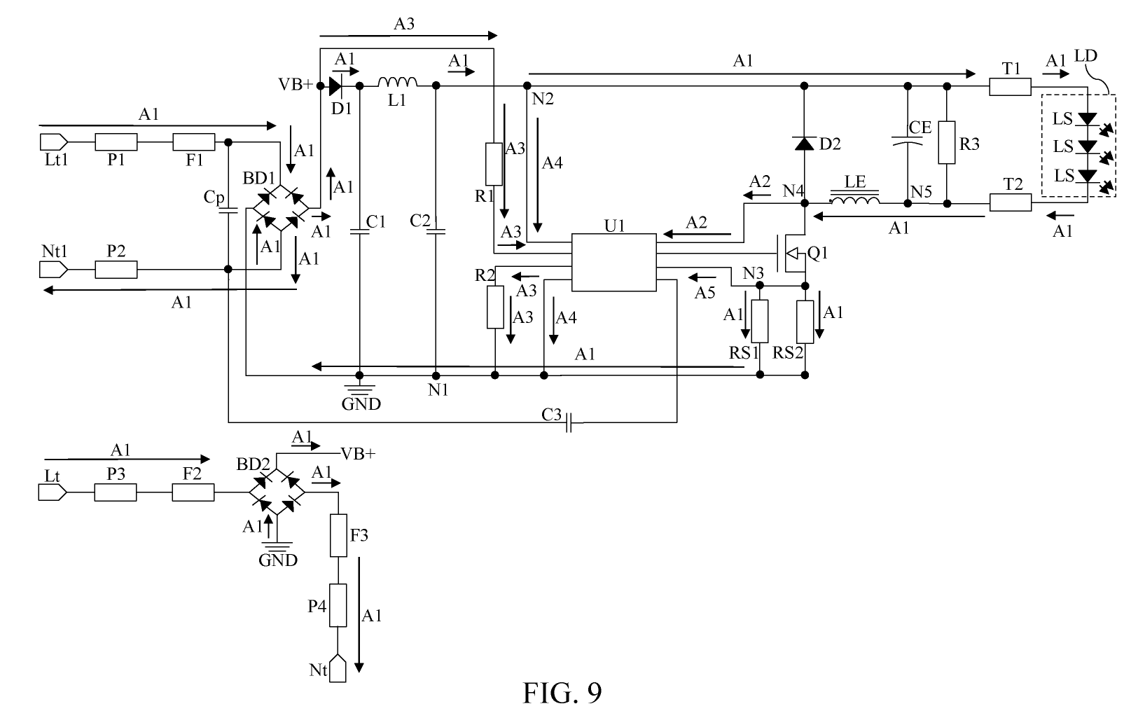

Please refer to FIG. 9, which is the schematic view of the utility power mode of the lighting device driver having the power controller in accordance with the sixth embodiment of the disclosure. As shown in FIG. 9, the load LD includes a plurality of light sources LS, which may be light-emitting diodes. The load LD is connected to the first output terminal T1 and the second output terminal T2 of the output unit 343. When the input module 31 is connected to the utility power (Lt1, Nt1, Lt, and Nt represent the output terminals of the utility power), the input module 31 couples the external input signal Is, and the rectification module 32 rectifies the input signal Is to generate a rectified signal. The impedance identification and detection unit 333 of the driving control module 33 detects the impedance of the rectified signal, as indicated by the arrow A3 (this signal corresponds to the second input signal Is2 in the fourth embodiment). The control unit 331 executes the utility power mode when the control unit 331 determines that the second input signal Is2 is a power frequency signal. The direct-current signal smoothing unit 334 converts the rectified signal into a smooth direct-current signal (used to drive the high-voltage power supply 23 in the fourth embodiment) to supply power to the driving control module 33, as indicated by the arrow A4. The sampling unit 342 of the power conversion module 34 generates a feedback signal according to the peak current during the conduction of the switch element 341. The control unit 331 adjusts the pulse-width modulation signal according to the feedback signal (this feedback signal is inputted to the peak current detector 17 in the fourth embodiment) to control the power conversion module 34 for power conversion, as indicated by the arrow A5. In this case, the switch element 341 is continuously turned on and off, allowing the power conversion module 34 to perform power conversion. The control unit 331 can also receive a zero-crossing detection signal from the fourth node N4, as indicated by arrow A2 (this signal corresponds to the third input signal Is3 in the fourth embodiment), to perform zero-crossing detection. The rectified signal drives the load LD via the power conversion module 34 (including the switch element 341, output unit 343, and sampling unit 342). The path of the rectified signal is shown by the arrow A1. The lighting device driver 3 can also operate in a direct-current power mode.

The embodiment just exemplifies the disclosure and is not intended to limit the scope of the disclosure; any equivalent modification and variation according to the spirit of the disclosure is to be also included within the scope of the following claims and their equivalents.

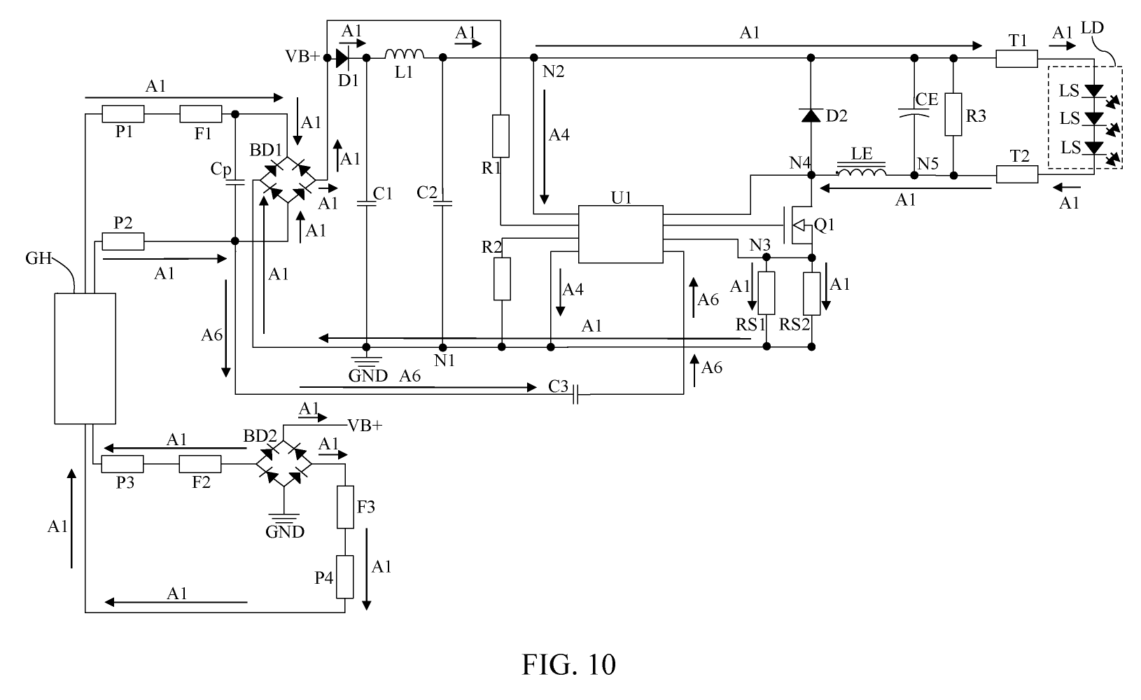

Please refer to FIG. 10, which is the schematic view of the ballast mode of the lighting device driver having the power controller in accordance with the sixth embodiment of the disclosure. As shown in FIG. 10, the load LD includes a plurality of light sources LS, which may be light-emitting diodes. The load LD is connected to the first output terminal T1 and the second output terminal T2 of the output unit 343. When the input module 31 is connected to the ballast GH, the input module 31 generates an input signal Is, and the rectification module 32 rectifies the input signal Is to generate a rectified signal. A portion of the input signal Is’ is coupled to the signal identification unit 332 via the capacitor Cp of the rectification module 32 (this signal corresponds to the first input signal Is1 in the fourth embodiment), as indicated by the arrow A6. The control unit 331 enters the ballast mode when the counting process identifies the signal as originating from the ballast GH. In the ballast mode, the control unit 331 generates a direct-current signal to control the continuous conduction of the switch element in the power conversion module 34. In this case, the switch element 341 remains in a continuously conducting state, forming a closed-loop circuit. Consequently, the rectified signal generated from the input signal of the ballast GH can directly drive the load LD. The direct-current signal smoothing unit 334 converts the rectified signal into a smooth direct-current signal to supply power to the driving control module 33, as indicated by the arrow A4. he rectified signal drives the load LD after being further smoothed via the power conversion module 34 (including the switch element 341, output unit 343, and sampling unit 342). The path of the rectified signal Rs is shown by the arrow A1.

The embodiment just exemplifies the disclosure and is not intended to limit the scope of the disclosure; any equivalent modification and variation according to the spirit of the disclosure is to be also included within the scope of the following claims and their equivalents.

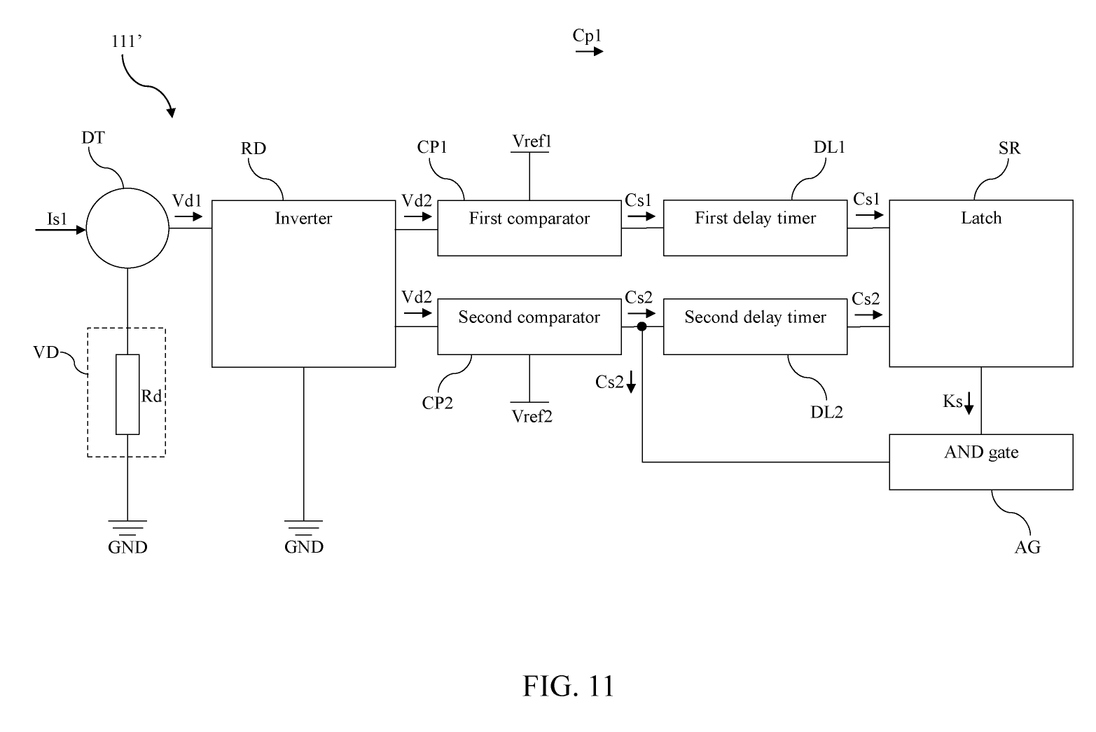

Please refer to FIG. 11, which is the block diagram of the circuit structure of the high-frequency signal identifier of the highly compatible power controller in accordance with the seventh embodiment of the disclosure. This embodiment exemplarily illustrates another circuit design of the high-frequency signal identifier. As shown in FIG. 11, the high-frequency signal identifier 111’ includes a voltage divider VD, an inverter RD, a first comparator CP1, a second comparator CP2, a first delay timer DL1, a second delay timer DL2, a latch SR, and an AND gate AG.

The first input signal Is1 is input through the detection (DET) pin DT of the power controller 1A. Then, the voltage divider VD divides the first input signal Is1 to generate a first divided-voltage signal Vd1. The voltage divider VD includes a voltage dividing resistor Rd. One end of the voltage dividing resistor Rd is connected to the detection pin DT of the power controller 1A, and the other end of the voltage dividing resistor Rd is connected to a ground GND. In another embodiment, the voltage divider VD may alternatively be a voltage dividing circuit including a plurality of resistors connected in series or in parallel.

The inverter RD is connected to the detection pin DT of the power controller 1A and the ground GND. The inverter RD performs common-mode noise suppression on the first divided-voltage signal Vd1 to generate a second divided-voltage signal Vd2, thereby clearly defining signal polarity, avoiding logic errors, and protecting operational amplifier functions. The circuit structure of the inverter RD is well known to those skilled in the art and therefore is not described in detail herein.

The first comparator CP1 is connected to the inverter RD. The first comparator CP1 compares the second divided-voltage signal Vd2 with a first reference voltage Vref1. When the second divided-voltage signal Vd2 is lower than the first reference voltage Vref1, the first comparator CP1 generates a first comparison signal Cs1 at low level. Conversely, when the second divided-voltage signal Vd2 is higher than the first reference voltage Vref1, the first comparator CP1 generates the first comparison signal Cs1 at high level. In this embodiment, the first reference voltage Vref1 is 1 V. In another embodiment, the first reference voltage Vref1 is 1.2 V. In yet another embodiment, the first reference voltage Vref1 is 1.3 V, which may be adjusted according to actual requirements. The circuit structure of the first comparator CP1 is well known to those skilled in the art and therefore is not described in detail herein.

The second comparator CP2 is connected to the inverter RD. The second comparator CP2 compares the second divided-voltage signal Vd2 with a second reference voltage Vref2 and generates a second comparison signal Cs2 at high level when the second divided-voltage signal Vd2 is higher than the second reference voltage Vref2. Conversely, when the second divided-voltage signal Vd2 is lower than the second reference voltage Vref2, the second comparator CP2 generates the second comparison signal Cs2 at low level. In this embodiment, the second reference voltage Vref2 is 2 V. In another embodiment, the second reference voltage Vref2 is 2.3 V. In yet another embodiment, the second reference voltage Vref2 is 2.5 V, which may be adjusted according to practical requirements. The circuit structure of the second comparator CP2 is well known to those skilled in the art and therefore is not described in detail herein.

The first delay timer DL1 delays the first comparison signal Cs1 by a first preset time. Accordingly, the first comparison signal Cs1 is input to the latch SR only after the first preset time has elapsed. In this embodiment, the first preset time may be 400 ns. The first delay timer DL1 may be a counter, a shift register, a D flip-flop, an RC delay circuit, or other similar components.

The second delay timer DL2 delays the second comparison signal Cs2 by a second preset time. Accordingly, the second comparison signal Cs2 is input to the latch SR only after the second preset time has elapsed. In this embodiment, the second preset time may be 300 ns. The first preset time may be greater than the second preset time. In another embodiment, the first preset time may be 300 ns and the second preset time may be 200 ns. In yet another embodiment, the first preset time may be 500 ns and the second preset time may be 400 ns, which may be adjusted according to actual requirements. The second delay timer DL2 may be a counter, a shift register, a D flip-flop, an RC delay circuit, or other similar components.

The latch SR is connected to the first delay timer DL1 and the second delay timer DL2. The latch SR receives the first comparison signal Cs1 and the second comparison signal Cs2, and generates a logic output signal Ks according to the first comparison signal Cs1 and the second comparison signal Cs2. When the first comparison signal Cs1 is at low level and the second comparison signal Cs2 is at high level, the latch SR generates the logic output signal Ks at high level. Conversely, when the first comparison signal Cs1 is at high level or the second comparison signal Cs2 is at low level, the latch SR generates the logic output signal Ks at low level. Since the first comparison signal Cs1 is input to the latch SR only after being delayed by the first preset time, and the second comparison signal Cs2 is input to the latch SR only after being delayed by the second preset time, the latch SR is capable of isolating timing of signal processing of the first comparison signal Cs1 and the second comparison signal Cs2, thereby preventing timing conflicts that could otherwise cause errors and ensuring correct generation of the logic output signal Ks. The circuit structure of the latch SR is well known to those skilled in the art and therefore is not described in detail herein.

The AND gate AG is connected to the latch SR and the second comparator CP2. The AND gate AG receives the logic output signal Ks and the second comparison signal Cs2, and generates a conduction signal when both the logic output signal Ks and the second comparison signal Cs2 are at high level.

Thereafter, the switch driver 12 activates the switch element 13 according to the conduction signal so as to execute the ballast mode.

As described above, in this embodiment, the second divided-voltage signal Vd2 may undergo dual-stage noise reduction through a noise suppression circuit including the first comparator CP1 and the second comparator CP2, and outputs of the first comparator CP1 and the second comparator CP2 are further processed by a multi-condition software logic operation mechanism provided by the latch SR and the AND gate. The above-described hardware-based dual noise reduction circuit and the multi-condition software logic operation mechanism can effectively resolve signal jitter issues of the first input signal Is1, thereby preventing malfunction of the driver, unstable light output, or reduced energy efficiency. Accordingly, the power controller 1A can satisfy actual requirements.

In addition, in this embodiment, the high-frequency signal identifier 111’ integrates the hardware-based dual noise reduction circuit and the multi-condition software logic operation mechanism, rather than adopting a filtering circuit with a fixed delay or a decision mechanism based on static thresholds. Therefore, the high-frequency signal identifier 111’ is capable of effectively improving system response speed while simultaneously enhancing interference immunity and stability in a high-frequency operating environment with substantial dynamic noise. Accordingly, the power controller 1A can satisfy actual requirements.

Furthermore, in this embodiment, the first comparator CP1 compares the second divided-voltage signal Vd2 with the first reference voltage Vref1 and generates the first comparison signal Cs1 when the second divided-voltage signal Vd2 is lower than the first reference voltage Vref1. The second comparator CP2 compares the second divided-voltage signal Vd2 with the second reference voltage Vref2 and generates the second comparison signal Cs2 when the second divided-voltage signal Vd2 is higher than the second reference voltage Vref2. Through the above-described multi-threshold cross-detection mechanism, the power controller 1A can ensure that the first input signal Is1 conforms to the startup characteristics of the ballast, thereby enabling the normal operation of the ballast mode.

The embodiment just exemplifies the disclosure and is not intended to limit the scope of the disclosure; any equivalent modification and variation according to the spirit of the disclosure is to be also included within the scope of the following claims and their equivalents.

It is worthy to point out that, in currently available LED lighting devices compatible with electronic ballasts, high-frequency signals are susceptible to multiple factors such as electromagnetic interference, power supply noise, and signal reflections, which easily cause signal jitter. Such phenomena may lead to malfunction of LED driver chips, unstable light output, or reduced energy efficiency, and in severe cases may even result in failure of the lighting device. Most currently available LED lighting devices attempt to address the above issues by using filtering circuits with fixed delays or decision mechanisms based on static thresholds. However, in high-frequency operating environments with substantial dynamic noise, such solutions have difficulty achieving an effective balance between system response speed and interference immunity, and therefore fail to satisfy actual requirements. By contrast, according to one embodiment of the disclosure, the power controller includes a signal identification element, a switch driver, and a switch element. The signal identification element includes a high-frequency signal identifier for receiving a first input signal. The high-frequency signal identifier includes a voltage divider, an inverter, a first comparator, a second comparator, a latch, and an AND gate. The switch driver is connected to the high-frequency signal identifier. The switch element is connected to the switch driver. The voltage divider divides the first input signal to generate a first divided-voltage signal. The inverter performs noise suppression on the first divided-voltage signal to generate a second divided-voltage signal. The first comparator compares the second divided-voltage signal with a first reference voltage and to generate a first comparison signal at low level when the second divided-voltage signal is lower than the first reference voltage. The second comparator compares the second divided-voltage signal with a second reference voltage and to generate a second comparison signal at high level when the second divided-voltage signal is higher than the second reference voltage. The latch generates a logic output signal at high level according to the first comparison signal and the second comparison signal. The AND gate generates a conduction signal when both the logic output signal and the second comparison signal are at high level. The switch driver activates the switch element according to the conduction signal. As described above, the second divided-voltage signal may undergo dual-stage noise reduction through a noise suppression circuit including the first comparator and the second comparator, and the outputs of the first comparator and the second comparator are further processed by a multi-condition software logic operation mechanism provided by the latch and the AND gate. The above-described hardware-based dual noise reduction circuit and the multi-condition software logic operation mechanism can effectively resolve signal jitter issues of the first input signal, thereby preventing malfunction of the driver, unstable light output, or reduced energy efficiency. Accordingly, the power controller can satisfy actual requirements.

In addition, according to one embodiment of the disclosure, the high-frequency signal identifier integrates the hardware-based dual noise reduction circuit and the multi-condition software logic operation mechanism, rather than adopting a filtering circuit with a fixed delay or a decision mechanism based on static thresholds. Therefore, the high-frequency signal identifier can effectively improve system response speed while simultaneously enhancing interference immunity and stability in a high-frequency operating environment with substantial dynamic noise. Accordingly, the power controller can satisfy actual requirements.

Further, according to embodiments of the disclosure, the first comparator compares the second divided-voltage signal with the first reference voltage and generates the first comparison signal when the second divided-voltage signal is lower than the first reference voltage. The second comparator compares the second divided-voltage signal with the second reference voltage and generates the second comparison signal when the second divided-voltage signal is higher than the second reference voltage. Through the above-described multi-threshold cross-detection mechanism, the power controller can ensure that the first input signal conforms to the startup characteristics of the ballast, thereby enabling the normal operation of the ballast mode.

Additionally, according to one embodiment of the disclosure, the high-frequency signal identifier of the power controller further includes a first delay timer and a second delay timer. The first delay timer delays the first comparison signal by the first preset time such that the first comparison signal is input to the latch only after the first preset time has elapsed. The second delay timer delays the second comparison signal by the second preset time such that the second comparison signal is input to the latch only after the second preset time has elapsed. Through the above-described delay mechanism, the latch is able to isolate timing of signal processing of the first comparison signal and the second comparison signal, thereby preventing timing conflicts that could otherwise cause errors. As a result, the reliability of the power controller can be significantly improved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A highly compatible power controller, comprising:
a signal identification element comprising a high-frequency signal identifier, wherein the high-frequency signal identifier comprises a voltage divider, an inverter, a first comparator, a second comparator, a latch, and an AND gate, and configured to receive a first input signal;
a switch driver connected to the high-frequency signal identifier; and
a switch element connected to the switch driver;
wherein the voltage divider is configured to divide the first input signal to generate a first divided-voltage signal, and the inverter is configured to perform noise suppression on the first divided-voltage signal to generate a second divided-voltage signal, wherein the first comparator is configured to compare the second divided-voltage signal with a first reference voltage and to generate a first comparison signal at a low level when the second divided-voltage signal is lower than the first reference voltage, wherein the second comparator is configured to compare the second divided-voltage signal with a second reference voltage and to generate a second comparison signal at a high level when the second divided-voltage signal is higher than the second reference voltage, wherein the latch is configured to generate a logic output signal at the high level according to the first comparison signal and the second comparison signal, and the AND gate is configured to generate a conduction signal when both the logic output signal and the second comparison signal are at the high level, and the switch driver is configured to activate the switch element according to the conduction signal.

2. The highly compatible power controller as claimed in claim 1, wherein the high-frequency signal identifier further comprises a first delay timer and a second delay timer, wherein the first delay timer is configured to delay the first comparison signal by a first preset time, whereby the first comparison signal is input to the latch only after the first preset time has elapsed, and the second delay timer is configured to delay the second comparison signal by a second preset time, whereby the second comparison signal is input to the latch only after the second preset time has elapsed.

3. The highly compatible power controller as claimed in claim 2, wherein the first preset time is greater than the second preset time.

4. The highly compatible power controller as claimed in claim 3, wherein the inverter and the voltage divider are connected to a detection pin, wherein the first input signal is input through the detection pin, and whereby the voltage divider divides the first input signal to generate the first divided-voltage signal.

5. The highly compatible power controller as claimed in claim 4, wherein one end of the voltage divider is connected to the detection pin, and another end of the voltage divider is connected to a ground.

6. The highly compatible power controller as claimed in claim 1, wherein the second reference voltage is higher than the first reference voltage.

7. The highly compatible power controller as claimed in claim 1, further comprising a reference voltage generator, a current controller, a time controller, a peak current detector, and a zero-crossing detector, wherein the signal identification element further comprises a direct-current signal identifier connected to the reference voltage generator, wherein the reference voltage generator is connected to the current controller, wherein the current controller is connected to the time controller and the peak current detector, wherein the time controller is connected to the zero-crossing detector, the peak current detector, and the switch driver, wherein the direct-current signal identifier is configured to receive a second input signal and, upon determining that the second input signal is a direct-current signal, output a direct-current identification signal to the reference voltage generator to generate a reference voltage, wherein the current controller is configured to generate a current control signal according to the reference voltage and a peak current detection signal of the peak current detector, wherein the time controller is configured to generate a first pulse-width modulation signal according to the current control signal, the peak current detection signal, and a zero-crossing detection signal of the zero-crossing detector to control the switch driver to control the switch element.

8. The highly compatible power controller as claimed in claim 7, further comprising an impedance identifier, wherein the signal identification element further comprises a power frequency signal identifier connected to the impedance identifier, and the impedance identifier is connected to the reference voltage generator, wherein the power frequency signal identifier is configured to receive a second input signal and, upon determining that the second input signal is a power frequency signal, output a power frequency identification signal to the reference voltage generator to generate the reference voltage, wherein the current controller is configured to generate the current control signal according to the reference voltage and the peak current detection signal, wherein the time controller is configured to generate a second pulse-width modulation signal according to the current control signal, the peak current detection signal, and the zero-crossing detection signal to control the switch driver to control the switch element.

9. The highly compatible power controller as claimed in claim 7, further comprising an overheat protector connected to the reference voltage generator, wherein the overheat protector transmits an overheat protection signal to the reference voltage generator to reduce the reference voltage when overheat protector detects that a temperature exceeds a temperature threshold.

10. The highly compatible power controller as claimed in claim 1, wherein the switch driver is a gate driver, and the switch element is a metal-oxide-semiconductor field-effect transistor.
